(19) United States
(12) Patent Application Publication
(10) Pub. No.: US 2014/0112187 A1
(43) Pub. Date: Apr. 24, 2014

(54) APPARATUS FOR FLOW-BASED NETWORK MONITORING AND NETWORK MONITORING SYSTEM

(71) Applicant: ELECTRONICS AND TELECOMMUNICATIONS RESEARCH INSTITUTE, Daejeon (KR)

(72) Inventors: Saehoon KANG, Daejeon (KR); Sunhee YANG, Daejeon (KR)

(73) Assignee: ELECTRONICS AND TELECOMMUNICATIONS RESEARCH INSTITUTE, Daejeon (KR)

(21) Appl. No.: 14/060,714

(22) Filed: Oct. 23, 2013

(30) Foreign Application Priority Data
Oct. 23, 2012 (KR) 10-2012-0118126
Oct. 2, 2013 (KR) 10-2013-0118040

(51) Int. Cl. H04L 12/26

(52) U.S. Cl. CPC H04L 43/0888
USPC 370/253

(57) ABSTRACT

An apparatus for extracting flow information for monitoring a network is provided. The flow extraction apparatus includes a sampling processor that samples a received packet according to a sampling rate, a flow matching processor that searches for a first flow matching rule that is matched to a first packet that is received from the sampling processor among flow matching rules that are stored at a first flow table and that updates first statistical information corresponding to the first flow matching rule according to a search result, and a controller that sets the sampling rate and a flow matching rule to be stored at the first flow table.

### CROSS-REFERENCE TO RELATED APPLICATION

This application claims priority to and the benefit of Korean Patent Application Nos. 10-2012-0118126 and 10-2013-0118040 filed in the Korean Intellectual Property Office on Oct. 23, 2012 and Oct. 2, 2013, the entire contents of which are incorporated herein by reference.

### BACKGROUND OF THE INVENTION

1. Field of the Invention

The present invention relates to a method and apparatus for supporting flow-based monitoring in a network and a network monitoring system using the method and apparatus.

2. Description of the Related Art

Flow-based network monitoring technology may be used in many fields such as for understanding a present situation and problem grasping of network traffic, traffic engineering, intrusion detection, QoS monitoring, accounting, and setting of a network line plan. Particularly, like a software defined network (SDN), in an environment in which an entire network is logically controlled in a flow unit by a controller, flow monitoring technology is essential in order to embody various network services in consideration of a network situation.

In general, a network monitoring system is formed with a flow extraction apparatus, a flow collection server, and a flow analysis server. The flow extraction apparatus extracts flow information of some or the entirety of a packet that is received to an input port and periodically transfers the flow information to the collection server. The flow collection server receives data from the flow extraction apparatus within a network and integrally manages the received data. The flow analysis server analyzes traffic according to a given purpose based on data that is collected by the flow collection server.

A method in which the flow extraction apparatus extracts flow information includes a complete survey method and a sampling survey method. The complete survey method is a method of extracting flow information of all received packets and has a merit that it provides very accurate and complete information of all traffic of a network, but the complete survey method has drawbacks that a resource request amount in the flow extraction apparatus is large, an additional load is caused at the network due to traffic increase to the flow collection server, and the additional load thus has an influence on existing traffic.

The sampling survey method is a method of extracting flow information by sampling only a portion of packets that are received in a flow extraction apparatus with a predetermined ratio, and has a merit that the required resource amount is relatively less in a flow extraction apparatus and that less burden is given to a network, but has a drawback that it is difficult to know accurate flow information and that information about flow having a short communication duration time is reported relatively less than information about flow having a long communication duration time.

Currently, the typical flow monitoring methods include NetFlow that was developed by Cisco and sFlow that was developed by sFlow.org consortium based on open source software. The NetFlow extracts flow information from the all or some (a packet sampled with a specific rate) of packets that are received in the flow extraction apparatus according to a previously defined flow granularity rule, counts them on a flow basis, and transfers the counted information to a collection server with a predetermined cycle. For example, when a flow granularity rule is defined to 5-tuple of IP, i.e., a source address, a destination address, a protocol, a source port, and a destination port, flow of a receiving packet is divided based on the five fields, and statistical information is managed on a flow basis. Further, as another example, when a flow granularity rule is defined to a source address and a destination address of IP, flow of a receiving packet is divided based on source address and destination address fields, and statistical information is managed on a flow basis.

Because the NetFlow classifies packets by a predetermined flow granularity rule, if a flow granularity rule is too minute, the NetFlow has a merit that monitoring is minutely performed, but has a drawback that data management cost and data transfer cost to a flow collection server are high. In contrast, when a flow granularity rule is too comprehensive, the NetFlow has a merit that data management cost and data transfer cost to a flow collection server are less, but has a drawback that it is difficult to know flow information of a minute unit.

A Flexible NetFlow of Cisco may dynamically designate several granularity rules, but has a drawback that a quantity of data to manage in a flow collection apparatus increases in proportion to the number of flow granularity rules.

The sFlow does not classify a receiving packet into a specific flow, extracts only header information of a packet, and immediately transmits the header information to a flow collection server. The sFlow has a merit that it can monitor flow by applying a flow rule of desired granularity in a flow analysis server, but has a drawback that a quantity of data that is transferred to a flow collection server is much larger than that of the NetFlow.

Another drawback of existing methods such as the NetFlow, the Flexible NetFlow, or the sFlow is that information about the entire flow that is classified according to a previously defined flow granularity rule is extracted without consideration of an interest level and an interest cycle on a flow basis and that all information that is extracted in the same cycle is transmitted to a flow collection server.

### SUMMARY OF THE INVENTION

From an application viewpoint using flow monitoring information, interest levels are different on a flow basis and flow that may be classified by comprehensive granularity may exist, flow that should be classified by minute granularity may exist, and flow having no necessity to collect may exist. According to an application, flow in which frequent monitoring is necessary may exist, and flow in which rare monitoring is sufficient may exist. When a flow extraction apparatus extracts flow information in consideration of an interest level and an interest cycle on a flow basis and transfers the extracted information to a flow collection server, a data quantity that the flow extraction apparatus manages and a data quantity to be transferred to the flow collection server may be optimized. Thereby, in order to transfer the extracted information to the flow collection server, a consumed bandwidth can be saved, and a load of the flow collection server can be reduced.

The present invention has been made in an effort to provide a method, apparatus, and network monitoring system having advantages of optimizing a data quantity that is managed in a flow extraction apparatus and a data quantity that is transferred to a flow collection server, and simultaneously reducing a network bandwidth that is consumed for flow monitoring.

An exemplary embodiment of the present invention provides a flow extraction apparatus that extracts flow information for network monitoring. The flow extraction apparatus includes: a sampling processor that samples a received packet according to a sampling rate; a flow matching processor that searches for a first flow matching rule that is matched to a first packet that is received from the sampling processor among flow matching rules that are stored at a first flow table and that updates first statistical information corresponding to the first flow matching rule according to a search result; and a controller that sets the sampling rate and a flow matching rule to be stored at the first flow table.

The flow extraction apparatus may further include a packet receiving processor that receives a packet from the outside and that transfers the packet to the sampling processor.

The flow extraction apparatus may further include a flow extractor that extracts flow information according to a flow extraction rule from a second packet that is received from the sampling processor and that stores the flow information at a second flow table. The controller may set the flow extraction rule.

The first flow table may include: at least one flow matching rule that is set by the controller; statistical information of flow that is defined by each flow matching rule; a transmitting cycle for transmitting each piece of statistical information; and an address of a flow collection server to receive each piece of statistical information.

The controller may set the transmitting cycle according to an interest level on a flow basis.

The flow matching processor may extract at least one field value from the first packet and search for whether the first flow matching rule having the same field value as the extracted field value exists at the first flow table.

The first statistical information may include a first packet count value. The flow matching processor may increase a first packet count value of the first statistical information when the first flow matching rule exists at the first flow table.

The second flow table may include at least one first field value that is extracted according to the flow extraction rule from the second packet, and second statistical information of flow that is defined by the at least one first field value.

The second flow table may further include an address of a flow collection server to receive the second statistical information.

The second statistical information may include a second packet count value. The flow extractor may increase a second packet count value of second statistical information corresponding to the second packet among second statistical information that is stored at the second flow table.

The flow extraction apparatus may further include a statistical information transmitting processor that transmits each of statistical information that is stored at the first flow table to a flow collection server address corresponding to each piece of statistical information at every transmitting cycle corresponding to each piece of statistical information.

The statistical information transmitting processor may transmit second statistical information that is stored at the second flow table to a default flow collection server address at every default cycle.

Another embodiment of the present invention provides a flow-based network monitoring system. The network monitoring system includes: a flow extraction apparatus that determines whether a receiving packet corresponds to interest flow using a flow matching rule and that updates statistical information of the interest flow according to whether a receiving packet corresponds to interest flow; a flow collection server that collects the statistical information from the flow extraction apparatus; a flow analysis server that analyzes statistical information that, is collected by the flow collection server and that determines the flow matching rule; and a monitoring controller that transmits the flow matching rule to the flow extraction apparatus by a request of the flow analysis server. The flow matching rule includes a value of at least one field of fields constituting a packet. The interest flow is defined by the flow matching rule.

The monitoring controller may designate the flow collection server as a server to receive the statistical information from the flow extraction apparatus, and may transfer the flow collection server address to the flow extraction apparatus.

Yet another embodiment of the present invention provides a flow-based software defined network (SDN) switch of an SDN system. The SDN switch includes: a flow matching processor that updates first statistical information of first flow that is defined by a first flow matching rule, when the first flow matching rule that is matched to a receiving packet exists at a flow table; and an action processor that processes the receiving packet according to an action corresponding to the first flow matching rule when the first flow matching rule exists at the flow table. The first flow matching rule includes at least one field value of field values of the receiving packet.

The action processor may include: a statistical information transmitting action module that transmits the first statistical information to a first flow collection server address corresponding to the first flow matching rule at every first transmitting cycle corresponding to the first flow matching rule; and a packet forwarding action module that forwards the receiving packet.

### BRIEF DESCRIPTION OF THE DRAWINGS

FIG. 1 is a diagram illustrating a network monitoring system according to an exemplary embodiment of the present invention.

FIG. 2 is a block diagram illustrating a flow extraction apparatus according to an exemplary embodiment of the present invention.

FIG. 3 illustrates an interest flow table according to an exemplary embodiment of the present invention.

FIG. 4 is a table illustrating an example of an interest flow matching rule field of FIG. 3.

FIG. 5 is a flowchart illustrating an interest flow matching processing procedure according to an exemplary embodiment of the present invention.

FIG. 6 illustrates a default flow table according to an exemplary embodiment of the present invention.

FIG. 7 is a flowchart illustrating a flow extraction processing procedure according to an exemplary embodiment of the present invention.

FIG. 8 is a block diagram illustrating an SDN switch and an SDN controller according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

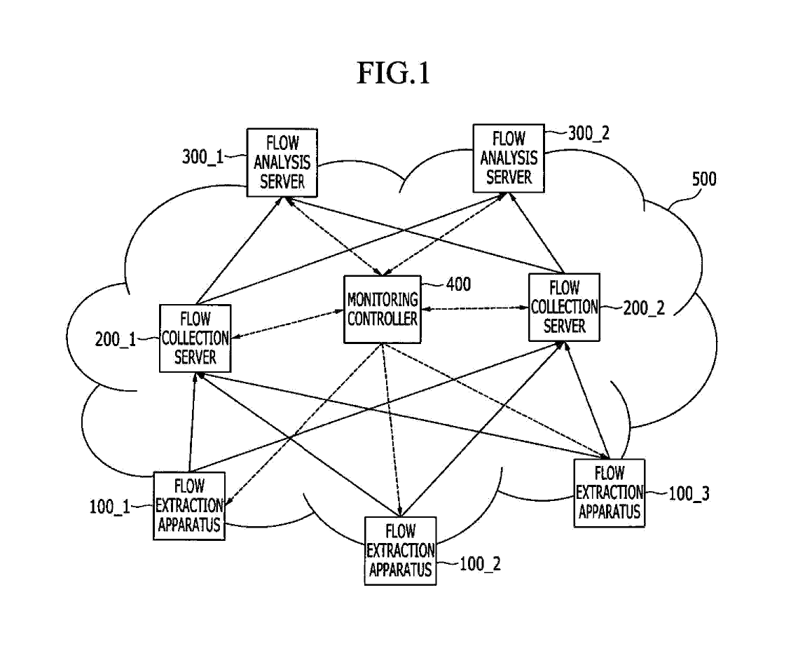

FIG. 1 is a diagram illustrating a network monitoring system according to an exemplary embodiment of the present invention.

The network monitoring system includes at least one flow extraction apparatus 100_1-100_3, at least one flow collection server 200_1-200_2, at least one flow analysis server 300_1-300_2, and a monitoring controller 400. Because the flow extraction apparatuses 100_1-100_3, the flow collection servers 200_1-200_2, the flow analysis servers 300_1-300_2, and the monitoring controller 400 are connected by the Internet 500, the flow extraction apparatuses 100_1-100_3, the flow collection servers 200_1-200_2, the flow analysis servers 300_1-300_2, and the monitoring controller 400 can mutually communicate. For convenience of description, FIG. 1 illustrates a case in which the network monitoring system includes three flow extraction apparatuses 100_1-100_3, two flow collection servers 200_1-200_2, and two flow analysis servers 300_1-300_2.

The flow extraction apparatuses 100_1-100_3 update statistical information on a flow basis by classifying a received packet on a flow basis according to the control of the monitoring controller 400, and transfer the updated statistical information to the designated flow collection servers 200_1-200_2. The flow collection servers 200_1-200_2, to receive statistical information from the flow extraction apparatuses 100_1-100_3, may be designated on each flow basis.

The flow collection servers 200_1-200_2 receive statistical information from the designated flow extraction apparatuses 100_1-100_3 and integrally manage the received statistical information, When the flow collection servers 200_1-200_2 receive a transmitting request from the designated flow analysis servers 300_1-300_2, the flow collection servers 200_1-200_2 transfer the collected statistical information to the designated flow analysis servers 300_1-300_2.

The flow analysis servers 300_1-300_2 analyze traffic according to a given purpose using statistical information that is received from the designated flow collection servers 200_1-200_2. The flow analysis servers 300_1-300_2 determine a flow matching rule of interested flow (hereinafter, “interest flow”), and transfer an interest flow matching rule to the monitoring controller 400 so that a flow matching rule of interest flow (hereinafter, an ‘interest flow matching rule’) is registered at the monitoring controller 400. The flow analysis servers 300_1-300_2 analyze statistical information of interest flow that is received from the designated flow collection servers 200_1-200_2 according to a given purpose.

The monitoring controller 400 manages an entire network monitoring system. When the monitoring controller 400 receives a monitoring request for interest flow from the flow analysis servers 300_1-300_2, the monitoring controller 400 notifies the flow analysis servers 300_1-300_2 that request monitoring of the flow collection servers 200_1-200_2 to collect statistical information about corresponding interest flow. The monitoring controller 400 instructs to update statistical information about corresponding interest flow to a specific apparatus of the flow extraction apparatuses 100_1-100_3. The monitoring controller 400 may designate appropriate flow collection servers 200_1-200_2 to receive statistical information from the flow extraction apparatuses 100_1-100_3 on an interest flow basis. The monitoring controller 400 periodically sends and receives a message to and from the flow collection servers 200_1-200_2, grasps a situation of the flow collection servers 200_1-200_2, and determines the flow collection servers 200_1-200_2 to collect statistical information of interest flow in consideration of the grasped situation.

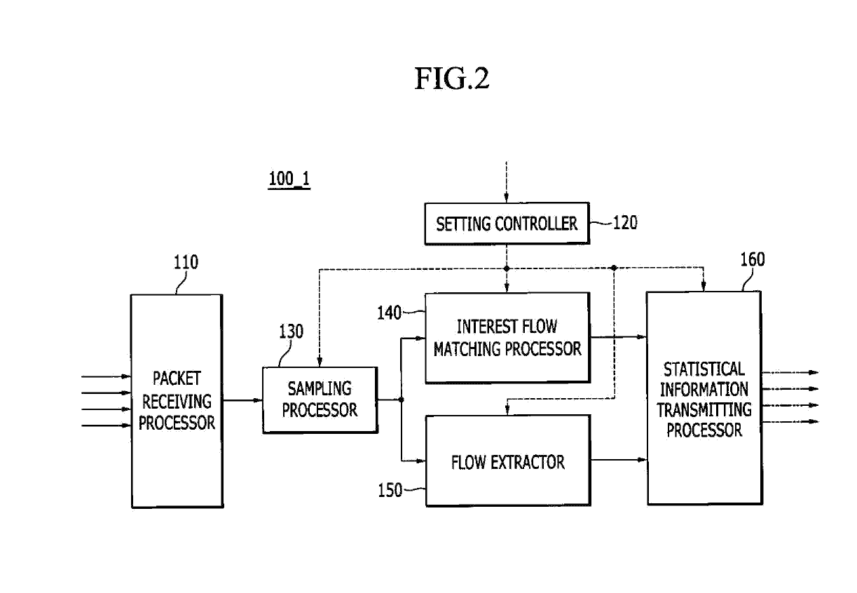

FIG. 2 is a diagram illustrating the flow extraction apparatus 100_1 according to an exemplary embodiment of the present invention.

The flow extraction apparatus 100_1 includes a setting controller 120, a packet receiving processor 110, a sampling processor 130, an interest flow matching processor 140, a flow extractor 150, and a statistical information transmitting processor 160.

The setting controller 120 receives control instructions from the monitoring controller 400 and sets operation of each of constituent elements 110 and 130-160. Here, the control instructions may include a sampling rate, addition and deletion (addition and deletion of an interest flow matching rule) of interest flow, definition and change of a flow extraction rule, designation of a transmitting cycle for transmitting extracted statistical information, and designation of a flow collection server to receive extracted statistical information. The sampling rate includes a sampling rate for sampling a packet to be transmitted to the interest flow matching processor 140 and a sampling rate for sampling a packet to be transmitted to the flow extractor 150. The transmitting cycle is set based on an interest level, an interest cycle, and accuracy of a requested measuring value on a flow basis.

The packet receiving processor 110 receives a packet from the outside and transfers the packet to the sampling processor 130.

The sampling processor 130 samples a packet according to a sampling rate that is set by the setting controller 120, and transfers the sampled packet to the interest flow matching processor 140 and the flow extractor 150. A sampling rate of the packet that is transferred to the interest flow matching processor 140, and the flow extractor 150 may be differently defined.

The interest flow matching processor 140 stores and manages an interest flow matching rule that is set by the setting controller 120 at an interest flow table. When an entry having an interest flow matching rule that is matched to a packet that is received from the sampling processor 130 exists at the interest flow table, the interest flow matching processor 140 updates statistical information about a corresponding interest flow matching rule. That is, the interest flow matching processor 140 updates statistical information of interest flow that is defined by a corresponding interest flow matching rule.

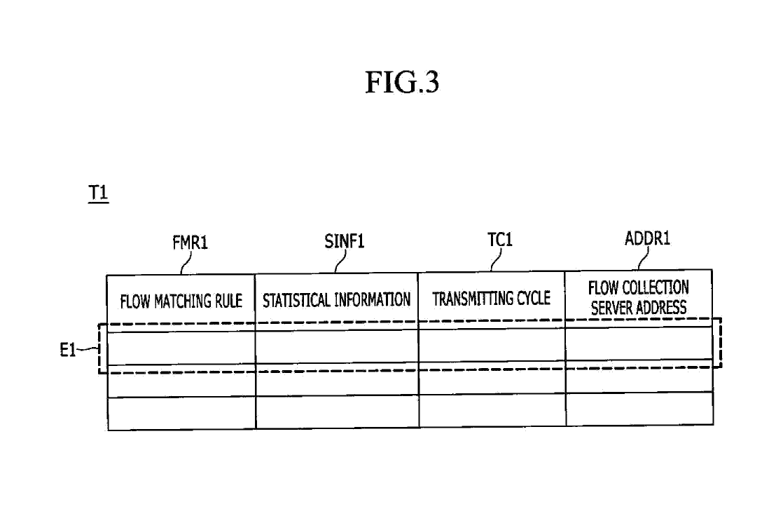

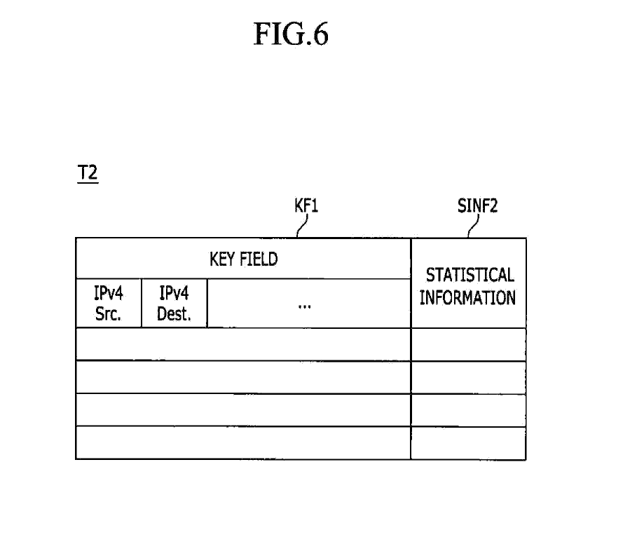

The flow extractor 150 performs flow extraction work of a packet that is received from the sampling processor 130 using a flow extraction rule that is set by the setting controller 120, and stores an extraction result thereof at a default flow table. An interest flow table and a default flow table will be described in detail with reference to FIGS. 3 and 6.

The statistical information transmitting processor 160 transmits statistical information that is managed by the flow extractor 150 to a default flow collection server address at every default transmitting cycle based on a default flow collection server address and a default transmitting cycle that are set by the setting controller 120. The statistical information transmitting processor 160 periodically transmits statistical information of interest flow that is managed by the interest flow matching processor 140 to a designated collection server. Specifically, when a flow collection server address and a transmitting cycle of corresponding interest flow are written at an interest flow table, the statistical information transmitting processor 160 transmits statistical information of corresponding interest flow using the written transmitting cycle and flow collection server address, and when a flow collection server address and a transmitting cycle of corresponding interest flow are not written at an interest flow table, the statistical information transmitting processor 160 transmits statistical information of corresponding interest flow with reference to a default transmitting cycle and a default collection server address.

FIG. 3 is a diagram illustrating an interest flow table T1 according to an exemplary embodiment of the present invention.

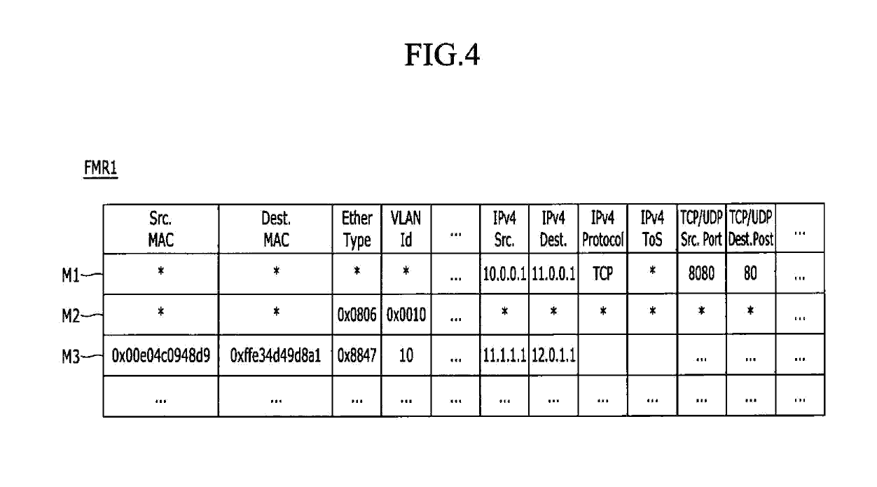

The interest flow table T1 basically includes an interest flow matching rule field FMR1 and a statistical information field SINF1 of corresponding interest flow. Here, the statistical information field SINF1 includes packet count information and byte count information. When designating a separate transmitting cycle and flow collection server on an interest flow basis, the interest flow table T1 may further additionally include a transmitting cycle field TC1 and a flow collection server address field ADDR1. A record that is formed with the interest flow matching rule field FMR1 the statistical information field SINF1, the transmitting cycle field TC1, and the flow collection server address field ADDR1 for one interest flow is referred to as an interest flow entry E1, and a plurality of interest flow entries E1 may exist at the interest flow table T1. An interest flow matching rule field FMR1 will be described in detail with reference FIG. 4.

FIG. 4 is a diagram illustrating an example of the interest flow matching rule field FMR1 of FIG. 3. FIG. 4 illustrates a plurality of interest flow matching rules M1-M3 that are included in the interest flow matching rule field FMR1.

The interest flow matching rules M1-M3 are used as a means for distinguishing interest flow. The interest flow matching rules M1-M3 are set based on an interest level, an interest cycle, and accuracy of a requested measuring value of corresponding interest flow. The interest flow matching miles M1-M3 are a combination of at least one field value of field values that may be extracted from a packet, and for some field, wild card matching may be allowed. Specifically, when a kind of a field in which matching is available is F1-FN (N>1), by designating field values V1-VN to the fields F1-FN, respectively, the interest flow matching rules M1-M3 may be defined. For example, it is defined that in an interest flow matching rule M1 of a first row, a source address of IPv4 is 10.0.0.1, a destination address of IPv4 is 11.0.0.1, a protocol of IPv4 is TCP, and a source and a destination port number of TCP/UDP are 8080 and 80, respectively, and packets having the same field value as that of the interest flow matching rule M1 are classified into one interest flow.

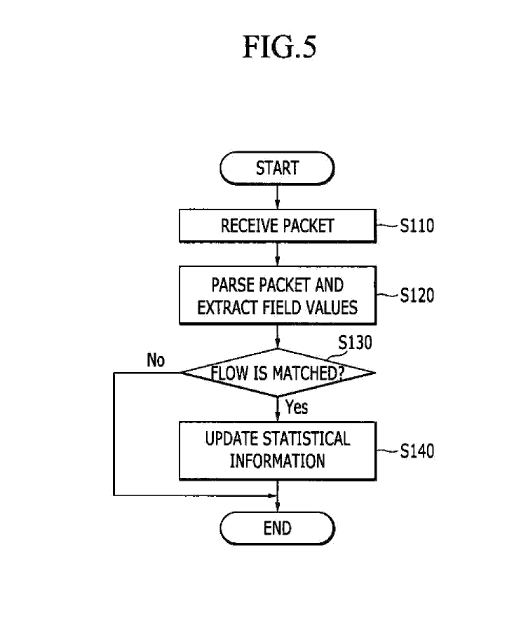

FIG. 5 is a flowchart illustrating an interest flow matching processing procedure according to an exemplary embodiment of the present invention. Referring to FIG. 5, an interest flow matching processing procedure will be described for when a packet is transferred to the interest flow matching processor 140. Hereinafter, for convenience of description, it is assumed that interest flow entries (e.g., E1) including an interest flow matching rule (e.g., M1-M3) are added to the interest flow table T1 by the setting controller 120.

The interest flow matching processor 140 receives a packet (S110).

The interest flow matching processor 140 parses a packet and extracts field values that may be used for previously defined interest flow matching (S120).

The interest flow matching processor 140 applies interest flow matching rules of the interest flow table T1 to the extracted field value and tests whether flow is matched (S130). That is, the interest flow matching processor 140 determines whether an interest flow matching rule having the same field value as the extracted field value exists at the interest flow table T1.

If an interest flow matching rule having the same field value as the extracted field value exists at the interest flow table T1, the interest flow matching processor 140 updates statistical information (packet count and byte count) of a statistical information field SINF1 of an interest flow entry corresponding to an interest flow matching rule (S140).

Interest flow matching processing may be selectively performed. Specifically, when an interest flow matching processing flag signal is activated, the interest flow matching processor 140 performs an interest flow matching processing procedure of FIG. 5, and when an interest flow matching processing flag signal is not activated, the interest flow matching processor 140 does not perform an interest flow matching processing procedure.

FIG. 6 is a diagram illustrating a default flow table T2 according to an exemplary embodiment of the present invention.

The default flow table T2 includes a key field KF1 and a statistical information field SINF2 that are used for classifying flow. The key field KF1 of the default flow table T2 is determined by a flow extraction rule that is transferred from the setting controller 120, and when a flow extraction rule is changed by the setting controller 120, a configuration of the key field KF1 is changed. The flow extraction nile is defined to fields to be used for classifying a packet. For example, when a flow extraction rule is defined to a combination of a source address IPv4 Src. of IPv4 and a destination address IPv4 Dest. of IPv4, packets in which values of two fields (IPv4 Src., IPv4 Dest.) are the same are classified into the same flow.

The default flow table T2 may further include a flow collection server address field (not shown). In this case, the statistical information transmitting processor 160 transmits statistical information of a flow entry in which a flow collection server address is not written at the default flow table T2 to a default flow collection server address, and the statistical information transmitting processor 160 transmits statistical information of a flow entry in which a flow collection server address is written at the default flow table T2 to a corresponding flow collection server address.

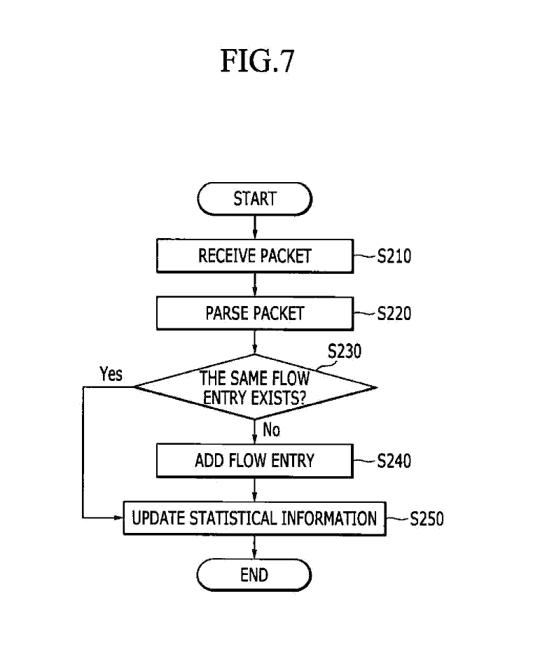

FIG. 7 is a flowchart illustrating a flow extraction processing procedure according to an exemplary embodiment of the present invention. Referring to FIG. 7, a flow extraction processing procedure of the flow extractor 150 will be described.

First, when the flow extractor 150 receives a packet (S210), the flow extractor 150 parses the packet and extracts key field (e.g., IPv4 Src., IPv4 Dest.) values (S220).

The flow extractor 150 tests whether the same flow entry exists at a default flow table T2 based on the extracted key field values (S230). That is, the flow extractor 150 determines whether a flow entry having the same field value as an extracted key field value exists at a default flow table T2.

If a flow entry having the same field value as an extracted key field value exists at a default flow table T2, the flow extractor 150 updates statistical information (packet count and byte count) of a statistical information field SINF2 of a corresponding flow entry (S250). If a flow entry having the same field value as an extracted key field value does not exist at a default flow table T2, the flow extractor 150 adds a flow entry of flow that is defined to an extracted key field value to the default flow table T2 (S240), and updates statistical information of a statistical information field SINF2 of the added flow entry (S250).

Flow extract processing of the flow extractor 150 may be selectively performed. Specifically, when a flow extraction processing flag signal is activated, the flow extractor 150 performs a flow extraction processing procedure of FIG. 7, and when a flow extraction processing flag signal is inactivated, the flow extractor 150 does not perform a flow extraction processing procedure.

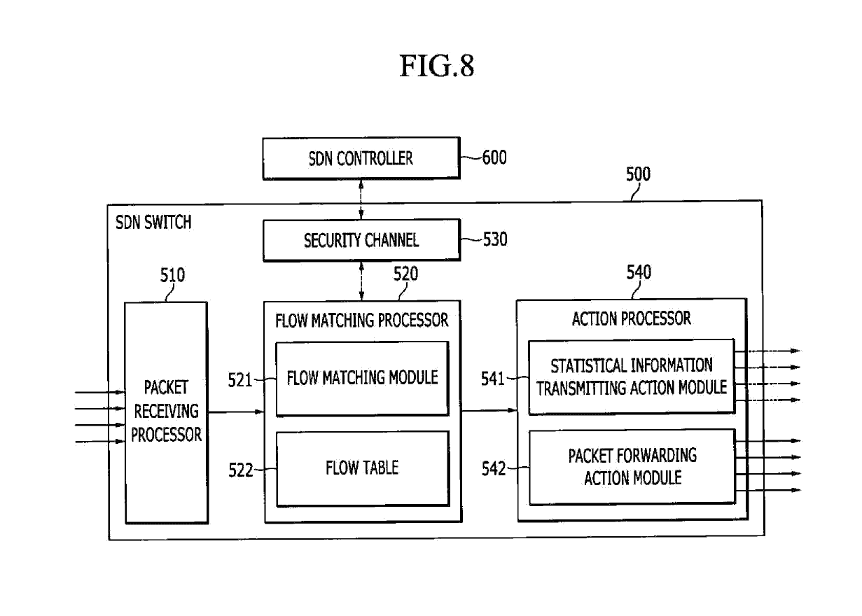

FIG. 8 is a diagram illustrating an SDN switch 500 and an SDN controller 600 according to an exemplary embodiment of the present invention. The present invention can be more easily embodied in a network system that naturally supports flow-based control like an SDN. FIG. 8 illustrates a case in which a flow extraction apparatus (e.g., 100_1) is embodied on a flow-based SDN switch such as open flow.

A characteristic of the SDN is that all traffic is logically divided and controlled in a flow unit by one SDN controller 600. For this purpose, the SDN switch 500 has a flow table 522 that is controlled by the SDN controller 600. The flow table 522 includes a flow matching rule that is defined as a field value for flow matching, an action to apply to a packet belonging to flow corresponding to each flow matching rule, and statistical information (packet count information, byte count) of flow corresponding to each flow matching rule.

A packet receiving processor 510 receives a packet and transfers the packet to a flow matching processor 520.

The flow matching processor 520 includes a flow matching module 521 and a flow table 522. The flow matching module 521 determines whether a flow entry having a flow matching rule that is matched to the received packet exists at the flow table 522.

If a flow entry having a flow matching rule that is matched to the received packet exists at the flow table 522, the flow matching processor 520 increases a statistical information count value of a corresponding flow entry, and an action processor 540 processes a packet according to a designated action of corresponding flow.

If a flow entry having a flow matching rule that is matched to the received packet does not exist at the flow table 522, the flow matching processor 520 transfers a receiving packet to the SDN controller 600 through a security channel 530 and updates the flow table 522 (e.g., adds a flow entry of a corresponding packet) according to instructions of the SDN controller 600. The action processor 540 processes a packet according to a designated action of corresponding flow.

The SDN switch 500 according to an exemplary embodiment of the present invention that extends a transmitting apparatus of an existing SDN switch can support flow monitoring. In the SDN switch 500, because all traffic is divided and processed in a flow unit, it is unnecessary to separately sample a packet, and because a flow matching rule is defined to an entire receiving packet, it is unnecessary to separately classify a packet according to a separate flow extraction rule. Therefore, the SDN switch 500 according to an exemplary embodiment of the present invention uses an existing SDN switch and can thus extract flow without the sampling processor 130 and the flow extractor 150 of FIG. 2.

The flow table 522 can be extended to additionally include a transmitting cycle field TC1 and a flow collection server address field ADDR1 like an interest flow table T1 of FIG. 3. When adding/updating a flow entry of specific flow to the flow table 522, the SDN controller 600 controls the flow matching processor 520 to describe a statistical information transmitting cycle and a flow collection server address to receive statistical information based on an interest level of corresponding flow and accuracy of a requested measuring value as well as a flow matching rule and an action to perform at the flow table 522.

The action processor 540 includes a statistical information transmitting action module 541 and a packet forwarding action module 542. Specifically, the packet forwarding action module 542 performs an action that forwards a receiving packet. The statistical information transmitting action module 541 performs an action that periodically transmits statistical information that is stored at the flow table 522 with reference to a corresponding transmitting cycle and a corresponding flow collection server address.

When a flow collection server address of a specific flow entry is not written at the flow table 522, the statistical information transmitting action module 541 may be designed to not transmit statistical information of corresponding flow. Further, when a flow collection server address of a specific flow entry is not written at the flow table 522, the statistical information transmitting action module 541 may be designed to transmit statistical information of corresponding flow to a default flow collection server address.

In the present invention, by differently applying granularity of flow distinction and a statistical information transfer cycle on a flow basis according to an interest level and an interest cycle on a flow basis in a flow analysis server, a flow extraction apparatus manages only necessary statistical information for a necessary time for flow monitoring.

Therefore, according to an exemplary embodiment of the present invention, while raising accuracy of a flow monitoring measuring value, a data quantity that a flow extraction apparatus should manage can be greatly reduced. Further, according to an exemplary embodiment of the present invention, by transferring only statistical information on a necessary flow basis to a flow collection server, a network bandwidth that is consumed for flow monitoring can be minimized.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A flow extraction apparatus that extracts flow information for network monitoring, comprising:
a sampling processor that samples a received packet according to a sampling rate;
a flow matching processor that searches for a first flow matching rule that is matched to a first packet that is received from the sampling processor among flow matching rules that are stored at a first flow table and that updates first statistical information corresponding to the first flow matching rule according to a search result; and
a controller that sets the sampling rate and a flow matching rule to be stored at the first flow table.

2. The flow extraction apparatus of claim 1, further comprising a packet receiving processor that receives a packet from the outside and that transfers the packet to the sampling processor.

3. The flow extraction apparatus of claim 2, further comprising a flow extractor that extracts flow information according to a flow extraction rule from a second packet that is received from the sampling processor and that stores the flow information at a second flow table,
wherein the controller sets the flow extraction rule.

4. The flow extraction apparatus of claim 3, wherein the first flow table comprises:
at least one flow matching rule that is set by the controller;
statistical information of flow that is defined by each flow matching rule;
a transmitting cycle for transmitting each piece of statistical information; and
an address of a flow collection server to receive each piece of statistical information.

5. The flow extraction apparatus of claim 4, wherein the controller sets the transmitting cycle according to an interest, level on a flow basis.

6. The flow extraction apparatus of claim 5, wherein the flow matching processor extracts at least one field value from the first packet and searches for whether the first flow matching rule having the same field value as the extracted field value exists at the first flow table.

7. The flow extraction apparatus of claim 6, wherein the first statistical information comprises a first packet count value, and
the flow matching processor increases a first packet count value of the first statistical information when the first flow matching rule exists at the first flow table.

8. The flow extraction apparatus of claim 7, wherein the second flow table comprises:
at least one first field value that is extracted according to the flow extraction rule from the second packet; and
second statistical information of flow that is defined by the at least one first field value.

9. The flow extraction apparatus of claim 8, wherein the second flow table further comprises an address of a flow collection server to receive the second statistical information.

10. The flow extraction apparatus of claim 8, wherein the second statistical information comprises a second packet count value, and
the flow extractor increases a second packet count value of second statistical information corresponding to the second packet among second statistical information that is stored at the second flow table.

11. The flow extraction apparatus of claim 10, further comprising a statistical information transmitting processor that transmits each of statistical information that is stored at the first flow table to a flow collection server address corresponding to each piece of statistical information at every transmitting cycle corresponding to each piece of statistical information.

12. The flow extraction apparatus of claim 11, wherein the statistical information transmitting processor transmits second statistical information that is stored at the second flow table to a default flow collection server address at every default cycle.

13. A flow-based network monitoring system, comprising:
a flow extraction apparatus that determines whether a receiving packet corresponds to interest flow using a flow matching rule and that updates statistical information of the interest flow according to whether a receiving packet corresponds to interest flow;
a flow collection server that collects the statistical information from the flow extraction apparatus;
a flow analysis server that analyzes statistical information that is collected by the flow collection server and that determines the flow matching rule; and
a monitoring controller that transmits the flow matching rule to the flow extraction apparatus by a request of the flow analysis server,
wherein the flow matching rule comprises a value of at least one field of fields constituting a packet, and
the interest flow is defined by the flow matching rule.

14. The network monitoring system of claim 13, wherein the flow extraction apparatus comprises:
a sampling processor that samples the receiving packet according to a sampling rate;
a flow matching processor that updates the statistical information, when the flow matching rule that is stored at an interest flow table is matched to a packet that is transferred from the sampling processor; and
a controller that receives the flow matching rule from the monitoring controller and that controls the flow matching processor so that the flow matching rule is stored at the interest flow table.

15. The network monitoring system of claim 14, wherein the interest flow table comprises:
the flow matching rule;
the statistical information;
a transmitting cycle for transmission of the statistical information; and
an address of the flow collection server to receive the statistical information.

16. The network monitoring system of claim 15, wherein the transmitting cycle is set based on an interest level of the interest flow.

17. The network monitoring system of claim 16, wherein the statistical information comprises a packet count value, and
the flow matching processor extracts at least one field value from a packet that is received from the sampling processor and increases a packet count value of the statistical information when the flow matching rule has the same field value as the extracted field value.

18. The network monitoring system of claim 13, wherein the monitoring controller designates the flow collection server as a server to receive the statistical information from the flow extraction apparatus and transfers the flow collection server address to the flow extraction apparatus.

19. A flow-based software defined network (SDN) switch of an SDN system, the SDN switch comprising:
a flow matching processor that updates first statistical information of first flow that is defined by a first flow matching rule, when the first flow matching rule that is matched to a receiving packet exists at a flow table; and
an action processor that processes the receiving packet according to an action corresponding to the first flow matching rule, when the first flow matching rule exists at the flow table,
wherein the first flow matching rule comprises at least one field value of field values of the receiving packet.

20. The SON switch of claim 19, wherein the action processor comprises:
a statistical information transmitting action module that transmits the first statistical information to a first flow collection server address corresponding to the first flow matching rule at every first transmitting cycle corresponding to the first flow matching rule; and
a packet forwarding action module that forwards the receiving packet.
